(19) United States
(12) Patent Application Publication
(10) Pub. No.: US 2006/0231150 A1
(43) Pub. Date: Oct. 19, 2006

(54) Methods and apparatus to reduce heat transfer from fluids in conduits

(75) Inventor: Dale E. Jamison, Humble, TX (US)

Correspondence Address: CRAIG W. RODDY;HALLIBURTON ENERGY SERVICES, P.O. BOX 1431, DUNCAN, OK, 73536-0440, US

(73) Assignee: Halliburton Energy Services, Inc.

(21) Appl. No.: 11/106,280

(22) Filed: Apr. 14, 2005

(51) Int. Cl. F16L 9/18

(52) U.S. Cl. 138/114; 138/112; 138/113; 138/148

(57) ABSTRACT

Methods and apparatus are provided for reducing heat transfer to or from a fluid contained within double-walled conduit. A method for reducing the heat transfer from a fluid contained within double-walled conduit includes providing an inner conduit, the inner conduit substantially containing the fluid; providing an outer conduit, the outer conduit substantially surrounding the inner conduit; and connecting the inner conduit to the outer conduit via at least one elongated conduction pathway so as to reduce the heat transfer from the fluid.

### BACKGROUND

The present invention relates to heat transfer applications, and more particularly, to methods and apparatus for reducing conduit-related heat transfer.

Fluids transported through long lengths of conduit can lose significant amounts of heat to the environment. This heat loss may be particularly problematic when a significant temperature differential exists between the transported fluid and its environment. One example of such a situation may be the flowing of a fluid through deepwater production piping from a deepwater oil and gas well to an oil and gas platform at the water surface. In such an example, a fluid may be transported long distances through deepwater production piping, typically anywhere from 600 ft to 8,000 ft. In some cases, the transported fluid may be significantly hotter than the temperature of its surrounding environment, in this case, the ocean water. In some cases, the ocean water can be as cold as −2° C.

Deepwater production pipe is often double-walled pipe, comprising an inner pipe and an outer pipe. These long pipes are often constructed by longitudinally joining shorter segments of pipe together to form longer lengths of pipe. The inner pipe may be generally joined to the outer pipe at each segment of pipe via a threaded connection or other suitable attachment means such as welding. Often, the inner pipe may be insulated from the outer pipe with an insulating material, an insulating fluid, or a vacuum. This insulation between the inner and outer pipes is thought to reduce the heat transfer from the fluid to the environment. Although this insulation barrier often separates most of length of the inner pipe from direct contact with the outer pipe, the inner pipe and outer pipe are often in direct contact at the joints between the pipe segments. This surface area of direct contact offers a more conductive heat transfer path than the other insulated portions of the pipe. Consequently, most of the heat loss from the fluid to the environment occurs at this zone of contact between the inner and outer pipe. Thus, one of the drawbacks of joining double-walled conduit together in segmented intervals may be the short conductive path formed between the inner and outer conduits at the joints of each conduit segment as it may increase the amount of heat transfer between the inner and outer conduits and therefore, the heat transfer from the contained fluid.

Heat loss from a transported fluid to the environment may be problematic for several reasons. In the case of deepwater hydrocarbon production piping, for example, the cooling of a transported fluid may cause crystallization or precipitation of undesirable solids, such as asphaltine, paraffin, or hydrates. In more severe cases, the recovered fluid may freeze or solidify in the pipe due to heat loss to the external environment, which may, in turn, pose further transportation difficulties with the fluid.

Another problem may be the heating of a fluid by a warmer environment. One example of such a situation is the transport of cryogenic fluids. Because of the temperature differential between cryogenic fluids and the surrounding environment, the heat transfer from the environment to the cryogenic fluid can be substantial. This heat transfer can be problematic for a variety of reasons, including pressure buildup in the pipe or ice formation on the pipe.

### SUMMARY

The present invention relates to heat transfer applications, and more particularly, to methods and apparatus for reducing conduit-related heat transfer.

An example of a method of the present invention of reducing heat transfer from a fluid comprises providing an inner conduit, the inner conduit substantially containing the fluid; providing an outer conduit, the outer conduit substantially surrounding the inner conduit; and connecting the inner conduit to the outer conduit via at least one elongated conduction pathway so as to reduce the heat transfer from the fluid.

An example of the present invention of a deepwater oil and gas production piping system for reducing heat loss from a contained fluid comprises a pipe segment, the pipe segment comprising an inner pipe; an outer pipe, the outer pipe substantially surrounding the inner pipe; and at least one elongated conduction pathway connecting the inner pipe to the outer pipe; and a plurality of pipe segments joined longitudinally to form a longer deepwater production piping system.

An example of a pipe apparatus of the present invention comprises an inner pipe; an outer pipe, the outer pipe substantially surrounding the inner pipe; and at least one elongated conduction pathway connecting the inner pipe and to the outer pipe so as to reduce the heat transfer from the fluid to the external environment.

The features and advantages of the present invention will be apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention and should not be used to limit or define the invention.

FIG. 1 shows a cross-sectional view of a double-walled conduit with inner and outer conduits connected via an elongated conduction path in accordance with one embodiment of the present invention.

FIG. 2 shows a cross-sectional view of a double-walled conduit with inner and outer conduits connected via an elongated conduction path having an optional port traversing the outer conduit in accordance with one embodiment of the present invention.

FIG. 3 shows a cross-sectional view of an apparatus incorporating certain embodiments of the elongated conduction path.

FIG. 4 illustrates a system with a deepwater production piping coupled to an offshore platform and a deepwater oil and gas well incorporating certain features of the present invention.

FIG. 5 illustrates a cross-sectional view of pipe segments before being joined together in accordance with one embodiment of the present invention.

### DESCRIPTION

The present invention relates to heat transfer applications, and more particularly, to methods and apparatus for reducing conduit-related heat transfer.

The present invention provides methods and apparatus useful in heat transfer applications. In particular, the methods and apparatus of the present invention may be particularly useful in reducing the heat transfer between a transported fluid and its environment when the fluid is contained in a double-walled conduit. By providing an elongated conduction path between the inner and outer conduits, the heat transfer between a transported fluid and its environment may be reduced. The term conduit, as used herein, refers to any pipe, tube, or channel that may be adapted for the transport of fluids.

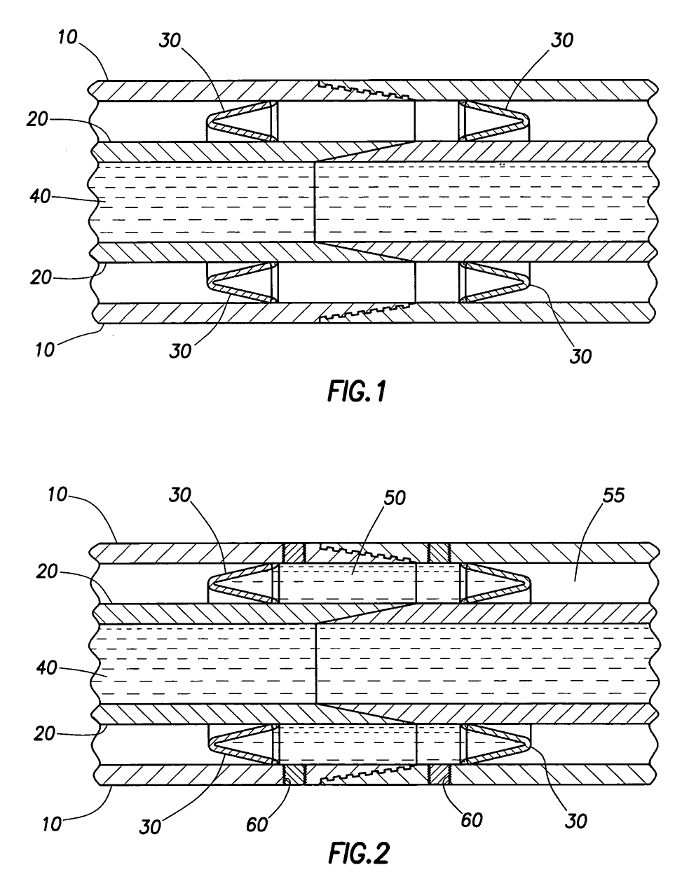

FIG. 1 shows a cross-sectional view of a double-walled conduit constructed of inner and outer conduits in accordance with one embodiment of the present invention. An outer conduit 10 is shown substantially surrounding an inner conduit 20. An elongated conduction pathway 30 is shown connecting the inner conduit 20 to the outer conduit 10.

In one embodiment, a fluid 40 may be provided substantially contained in the inner conduit 20. The fluid 40 may be flowing through the inner conduit 20. Occasionally, the fluid 40 may not be flowing in the inner conduit 20 and may simply rest stationary, possibly due to operational considerations.

An elongated conduction pathway 30 may conductively join the inner conduit 20 and the outer conduit 10 in the vicinity of the joints between the conduit segments. Further, the elongated conduction pathway 30 may be formed by any geometric extension or series of extensions of the conduction pathway between the inner and outer conduits 10 and 20. This geometric extension may be any extension or lengthening of at least a portion of the conduction pathway directed away from the perpendicular of the surfaces of the conduits 10 and 20. Stated otherwise, at least one elongated conduction pathway may be longer than the length traversed by a straight line between the inner and outer conduits. In certain embodiments, a portion of the geometric extension may be at an angle oblique to the planes formed by the surfaces of the conduits 10 and 20. The heat transfer through the conduit from the fluid may be reduced, among other ways by extending the conduction pathway. In many instances, this heat transfer may be a cooling of a warmer fluid by a cooler external environment. In other instances, however, the heat transfer may be a heating of a colder fluid by a warmer environment.

The attachment of the elongated conduction pathway 30 to the inner conduit 20 and to the outer conduit 10 may be by welding or by any variety of methods known by one skilled in the art. Although the connection depicted in FIG. 1 shows the elongated conduction pathway 30 as the only connection between the inner and outer conduits 10 and 20, other connections besides the elongated conduction pathway 30 may be provided. Illustrative examples of other types of connections include, but are not limited to, welds, fasteners, adhesives, and other suitable coupling devices.

Additionally, insulation material may optionally be provided between the inner and outer conduits 10 and 20. This insulation material may reduce the heat transfer between the inner and outer conduits along a substantial portion of the conduit segments.

The outer conduit 10 may substantially surround the inner conduit 20 along most of the length of the conduits 10 and 20. In certain embodiments, the outer conduit 10 may or may not surround the inner conduit 20 in the vicinity of the joints between the conduit segments. Thus, “substantially surrounding” as used herein does not require that the outer conduit 20 surround the inner conduit in the vicinity of the conduit segment joints. Further, “substantially surrounding” does not require that the outer conduit 10 surround those portions of the inner conduit 20 where no outer conduit 10 is present.

The inner and outer conduits 10 and 20 may be constructed of any material that can withstand the pressures imposed upon them during operation. Pressures on the conduits 10 and 20 may be caused in part by the external environment, which in some cases may be water, e.g., in an off-shore well situation, or by the fluid 40 contained in the inner conduit 20. In certain embodiments, the conduits 10 and 20 may be constructed of any ceramic, plastic, or metal including, but not limited to, stainless steel.

Although not depicted here, in certain embodiments, the outer conduit may be further surrounded by another pipe or a plurality of pipes to provide additional layers of heat transfer resistance between the fluid and its environment.

FIG. 2 shows a cross-sectional view of a double-walled conduit with inner and outer conduits 10 and 20 connected via an elongated conduction path 30 having an optional port 60 traversing the outer conduit 10 in accordance with one embodiment of the present invention.

In certain embodiments, at least one optional port 60 may be provided to pull a vacuum on an enclosed space circumscribed by the elongated conduction pathways 30 and the inner and outer conduits 10 and 20. Alternatively, one or more ports 60 may be used to fill the enclosed space with an insulating fluid 50. The insulating fluid 50 may comprise any fluid with a low thermal conductivity. Low thermal conductivity fluids include fluids with a thermal conductivity below about 1 Btu/(hr ft ° F).

Further, the insulation fluid 50 may be a gelled or viscosified insulation fluid. Gelling or viscosifying the insulation fluid 50 may reduce any heat transfer due to convection that might otherwise occur if the insulation fluid 50 were not gelled or viscosified.

FIG. 3 shows a cross-sectional view of an apparatus incorporating certain embodiments of the elongated conduction path 30. In particular, the elongated conduction pathway 30 may conductively join the inner conduit 20 and the outer conduit 10 in the vicinity of the joints between the conduit segments. Further, the elongated conduction pathway 30 may be formed by any geometric extension or series of extensions of the conduction pathway between the inner and outer conduits 10 and 20. This geometric extension may be any extension or lengthening of at least a portion of the conduction pathway directed away from the perpendicular of the surfaces of the conduits 10 and 20. Stated otherwise, at least one elongated conduction pathway may be longer than the length traversed by a straight line between the inner and outer conduits. In certain embodiments, a portion of the geometric extension may be at an angle oblique to the planes formed by the surfaces of the conduits 10 and 20. Further, as shown in FIG. 3, a portion or portions of the geometric extension of the conduction pathway may be parallel to the surface of the conduits in addition to those portion or portions of the geometric extension that are at an angle oblique to the surface of the conduits.

Additionally, as one skilled in the art with the benefit of this disclosure will appreciate, the elongated conduction pathway may be separately provided via another member or members distinct from the inner conduit and/or outer conduit. Alternatively, the elongated conduction pathway may be formed by a lengthening of a portion of the inner conduit and/or the outer conduit. Further, although not depicted here, the elongated conduction pathways may use bracing members to provide additional structural support to the elongated conduction pathway. In certain embodiments, these bracing members may comprise an insulating material.

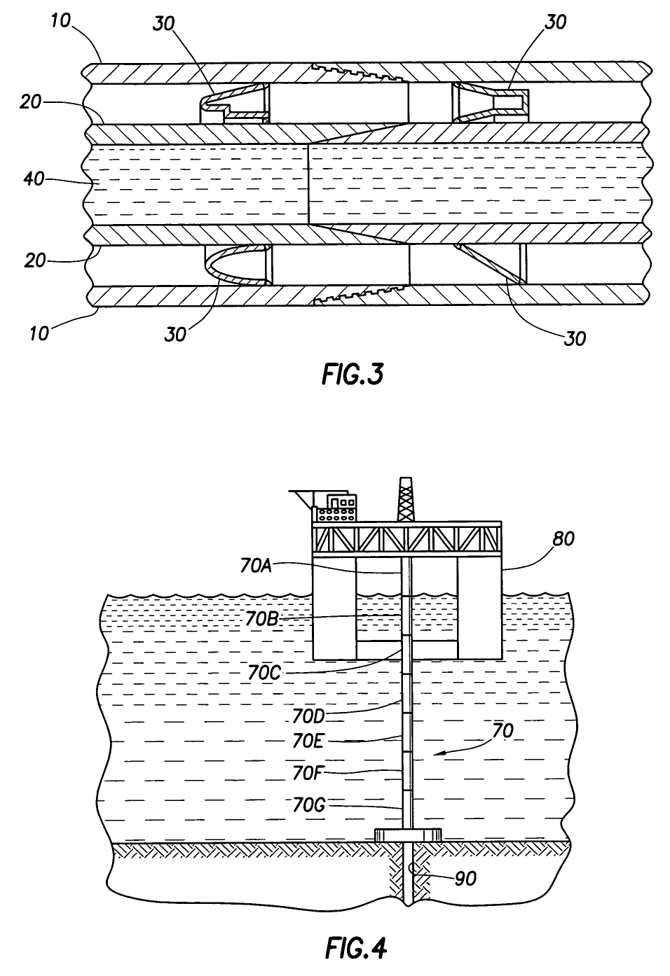

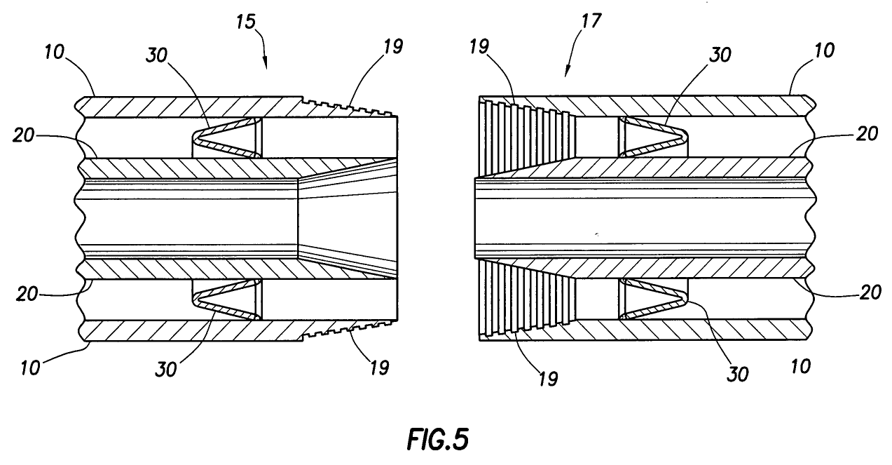

FIG. 4 illustrates a system having a deepwater production piping coupled to an offshore platform and a deepwater oil and gas well incorporating certain features of the present invention.

In one embodiment, an oil and gas well 90 may be coupled to the oil and gas deepwater production piping 70 which may in turn be coupled to an offshore platform 80. The deepwater production piping 70 may be formed by longitudinally joining shorter segments of conduit 70A-70G together. Although not depicted here, in certain embodiments, the deepwater production piping 70 may extend below the surface of the ground to reduce heat transfer between the fluid and its surrounding environment.

FIG. 5 illustrates a cross-sectional view of pipe segments before being joined together in accordance with one embodiment of the present invention. Though the present invention may be assembled in a variety of ways and sequences, this figure illustrates one embodiment of the pipe segments before assembly in the field. One end 15 of a portion of segmented pipe mates with another end 17 of a segmented pipe. In this case, the outer conduit of both ends 15 and 17 have threaded connections 19 which allow the ends 15 and 17 to be coupled together. In these embodiments, a seal is formed between segments of inner conduit via an an o-ring or elastomeric seal 32. In further embodiments, the segments of inner conduit may mate via an interference fit which forms a metal to metal seal or other types of sealing methods known in the art may be provided to further seal the union between the inner conduit segments.

An example of a method of the present invention of reducing heat transfer from a fluid comprises providing an inner conduit, the inner conduit substantially containing the fluid; providing an outer conduit, the outer conduit substantially surrounding the inner conduit; and connecting the inner conduit to the outer conduit via at least one elongated conduction pathway so as to reduce the heat transfer from the fluid.

Therefore, the present invention is well adapted to attain the ends and advantages mentioned as well as those that are inherent therein. While numerous changes may be made by those skilled in the art, such changes are encompassed within the spirit of this invention as defined by the appended claims. The terms in the claims have their plain, ordinary meaning unless otherwise explicitly and clearly defined by the patentee.

1. A method of reducing heat transfer from a fluid in a hydrocarbon production conduit system comprising:
providing an inner conduit, the inner conduit substantially containing the fluid;
providing an outer conduit, the outer conduit substantially surrounding the inner conduit; and
connecting the inner conduit to the outer conduit via at least one elongated conduction pathway so as to reduce the heat transfer from the fluid in the hydrocarbon production conduit system, the elongated conduction pathway not including a conduction path traversing a shortest distance between the inner conduit and the outer conduit.

2. The method of claim 1 wherein the inner conduit is a pipe; and
wherein the outer conduit is a pipe.

3. The method of claim 1 wherein the elongated conduction pathway is formed by positioning at least a portion of the elongated conduction pathway at an angle oblique to the walls of the conduits.

4. The method of claim 1 wherein the elongated conduction pathway is formed by positioning at least a portion of the elongated conduction pathway directed away from the perpendicular of the walls of the conduits.

5. (canceled)

6. The method of claim 1 wherein the outer conduit forms part of a hydrocarbon production piping system.

7. The method of claim 1 wherein the outer conduit has a threaded connection at one end of the outer conduit for mating with another section of conduit.

8. The method of claim 1 wherein at least one end of the inner conduit is adapted to form a metal to metal seal with another section of conduit.

9. The method of claim 1 wherein at least one end of the inner conduit comprises an elastomeric seal for forming a seal with another section of conduit.

10. The method of claim 1 ftrther comprising an additional conduit substantially surrounding the outer conduit.

11. The method of claim 1 wherein the connecting of the inner conduit to the outer conduit is made via at least two elongated conduction pathways so as to form an enclosed space circumscribed by the intersection of the at least two conduction pathways, the inner conduit and the outer conduit; and
providing at least one port traversing the outer conduit.

12. The method of claim 11 further comprising providing at least one additional port traversing the outer conduit to the enclosed space.

13. The method of claim 11 further comprising pulling a vacuum on the enclosed space.

14. A deepwater hydrocarbon production piping system for reducing heat loss from a contained fluid comprising:
a pipe segment, the pipe segment comprising an inner pipe; an outer pipe, the outer pipe substantially surrounding the inner pipe; and at least one elongated conduction pathway connecting the inner pipe to the outer pipe, the elongated conduction pathway not including a conduction path traversing a shortest distance between the inner pipe and the outer pipe; and
a plurality of pipe segments joined longitudinally to form a deepwater hydrocarbon production piping system.

15. A pipe apparatus comprising:
an inner pipe;
an outer pipe, the outer pipe substantially surrounding the inner pipe; and
at least one elongated conduction pathway connecting the inner pipe to the outer pipe, the elongated conduction pathway not including a conduction path traversing a shortest distance between the inner pipe and the outer pipe so as to reduce the heat transfer from a fluid to an external environment.

16. The pipe apparatus of claim 15 wherein the elongated conduction pathway is longer than the length traversed by a straight line between the inner pipe and the outer pipe.

17. The pipe apparatus of claim 15 wherein the outer pipe has a threaded connection at one end of the outer pipe for mating with another section of pipe.

18. The pipe apparatus of claim 15 further comprising a means for attaching the inner pipe to the outer pipe and for reducing thermal conductivity between the pipes.

19. The pipe apparatus of claim 15 wherein at least one end of the inner pipe is adapted to form a seal with another pipe apparatus.

20. (canceled)

21. The deepwater hydrocarbon production piping system of claim 14 wherein the connecting of the inner conduit to the outer conduit is made via at least two elongated conduction pathways so as to form an enclosed space circumscribed by the intersection of the at least two conduction pathways, the inner conduit and the outer conduit and further comprising at least one additional port traversing the outer conduit to the enclosed space.

22. The deepwater hydrocarbon production piping system of claim 14 further comprising a means for attaching the inner pipe to the outer pipe and for reducing thermal conductivity between the pipes.
